(19) United States
(12) Patent Application Publication
(10) Pub. No.: US 2025/0113163 A1
(43) Pub. Date: Apr. 3, 2025

(54) Location Operations Using Inertial Measurement Unit (IMU) Data

(71) Applicant: Apple Inc., CUPERTINO, CA (US)

(72) Inventors: Vignesh Babu MOORTHY, San Jose, CA (US); Benjamin A WERNER, San Jose, CA (US)

(21) Appl. No.: 18/899,414

(22) Filed: Sep. 27, 2024

Related U.S. Application Data
(60) Provisional application No. 63/586,662, filed on Sep. 29, 2023.

(51) Int. Cl. H04W 4/02; H04W 4/029

(52) U.S. Cl. CPC H04W 4/027; H04W 4/029

(57) ABSTRACT

An apparatus configured to generate, for transmission to a second wireless communication device, a request to initiate a ranging operation, process, based on one or more signals received from the wireless communication device, a response indicating that the apparatus is to locate the wireless communication device, collect inertial measurement unit (IMU) data, from at least one of the apparatus or the wireless communication device and generate an arrow to be displayed based on at least the IMU data, the arrow indicating a direction of the wireless communication device relative to the apparatus.

### PRIORITY/INCORPORATION BY REFERENCE

This application claims priority to U.S. Provisional Application Ser. No. 63/586,662 filed on Sep. 29, 2023, entitled “People Finding Operations Using Inertial Measurement Unit (IMU) Data,” the entirety of which is incorporated by reference herein.

### BACKGROUND

There are various mechanisms that allow wireless communication devices to locate one another. Some mechanisms use these features to dynamically generate directions that enable a user of one device to locate another device. For example, a first wireless communication device may receive information from a second wireless communication device that is used to determine the direction of the second wireless communication device relative to the first wireless communication device. The first wireless communication device may then output directions that enable its user to navigate to the second wireless communication device.

### SUMMARY

Some example embodiments are related to an apparatus having processing circuitry configured to generate, for transmission to a second wireless communication device, a request to initiate a ranging operation, process, based on one or more signals received from the wireless communication device, a response indicating that the apparatus is to locate the wireless communication device, collect inertial measurement unit (IMU) data, from at least one of the apparatus or the wireless communication device and generate an arrow to be displayed based on at least the IMU data, the arrow indicating a direction of the wireless communication device relative to the apparatus.

Other example embodiments are related to a method for generating, for transmission to a second wireless communication device, a request to initiate a ranging operation, process, based on one or more signals received from the wireless communication device, a response indicating that the apparatus is to locate the wireless communication device, collecting inertial measurement unit (IMU) data, from at least one of the apparatus or the wireless communication device and generating an arrow to be displayed based on at least the IMU data, the arrow indicating a direction of the wireless communication device relative to an apparatus performing the method.

### BRIEF DESCRIPTION OF THE DRAWINGS

FIG. 1 shows an example arrangement according to various example embodiments.

FIG. 2 shows an example wireless communication device according to various example embodiments.

FIG. 3 shows a method for performing a find location operation between the first wireless communication device and the second wireless communication device according to various example embodiments.

FIG. 4 shows an example architecture for a finder and findee according to various example embodiments.

FIG. 5 shows examples of an arrow directing the finder to the findee according to various example embodiments.

FIG. 6 shows a method for arrow generation according to various example embodiments.

### DETAILED DESCRIPTION

The example embodiments may be further understood with reference to the following description and the related appended drawings, wherein like elements are provided with the same reference numerals. The example embodiments relate to a mechanism that enables a user of one wireless communication device to locate another wireless communication device and/or user thereof.

The example embodiments are described with regard to wireless communication devices. As will be described in greater detail below, the wireless communication devices may include any electronic component configured with the hardware, software, and/or firmware to establish a short-range wireless connection to another wireless communication device and communicate with a network.

Some example embodiments include the use of short-range communication connections. In some examples, a short-range communication connection may be a Bluetooth connection, e.g., Bluetooth Classic, Bluetooth Low-Energy (BLE), etc. This is only an example and the principles described herein for the example embodiments may be applied to other types of short-range communication connections. Therefore, any reference to terms such as, “Bluetooth,” “short-range communication protocol,” “short-range connection,” or “short-range communication link” are provided for illustrative purposes and not intended to limit the example embodiments to any particular type of wireless communication protocol.

Some example embodiments include the use of ultra-wideband (UWB) communication connections. Other example embodiments include the use of cellular network connections or another wireless network connection such as a wireless local area network (WLAN) or a wide area network (WAN).

The example embodiments are also described with reference to a finder and a findee. In this context, the “findee” may generally refer to the wireless communication device and/or user thereof that is sharing their location with others. The “finder” may generally refer to the wireless communication device and/or user thereof that receives location information from another user. To provide a non-limiting example, a finder may receive information from the findee that is used to determine the direction of the findee relative to the finder. The finder may dynamically output directions that enable its user to navigate to the findee.

The example embodiments are further described with regard to an inertial measurement unit (IMU). The IMU may be a component of a wireless communication device comprising sensors such as, but not limited to, a gyroscope and accelerometer. It has been identified that it may be beneficial to utilize data collected by the IMU of the findee and/or finder to generate directions that enable the user of the finder to navigate to the findee. The IMU of the findee and/or finder device may generate IMU data. The findee and/or finder device may use the IMU data at least in part to generate directions that enable the user of the finder to navigate to the findee.

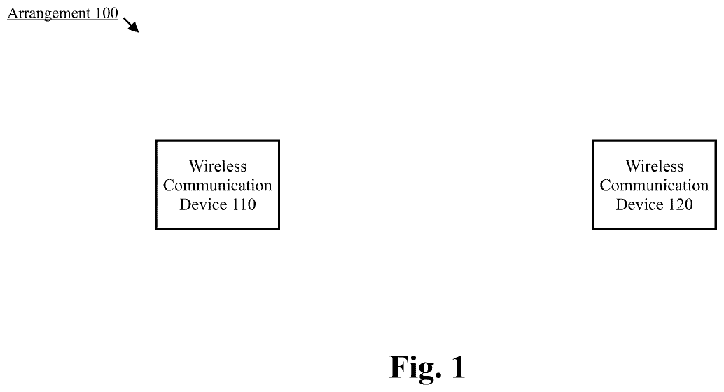

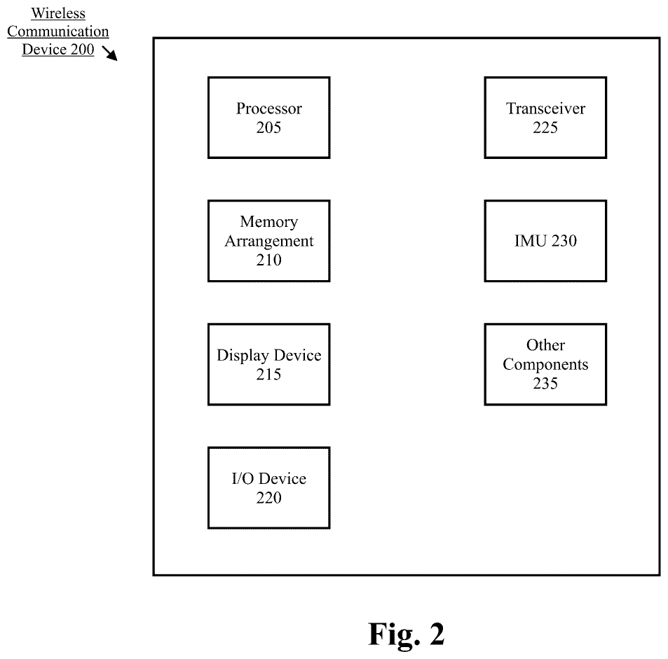

FIG. 1 shows an example arrangement 100 according to various example embodiments. The example arrangement 100 includes a first wireless communication device 110 and a second wireless communication device 120. Examples of these wireless communication devices 110 and 120 will be described in greater detail below with regard to FIG. 2. In the example of FIG. 1, the first wireless communication device 110 and the second wireless communication device 120 may not currently have a direct connection to each other.

In this example, the user of the first wireless communication device 110 may wish to locate the user of the second wireless communication device 120. As will be described in greater detail below, the users of the first and second wireless communication devices 110 and 120 may form a relationship that allows the first and second wireless communication devices 110 and 120 to find each other. In the example of the user of the first wireless communication device 110 wishing to locate the user of the second wireless communication device 120, the second wireless communication device 120 and/or user thereof may be considered to be the “findee,” (e.g., sharing their location with others) and the first wireless communication device 110 and/or user thereof may be considered to be the “finder,” e.g., receiving location information from another user.

In non-limiting examples, the finder 110 may move towards the findee 120; in other scenarios the finder 110 and the findee 120 may both be moving. In some examples, the finder 110 may be above or below the findee 120. For instance, in a building with multiple levels or floors, or in an outdoor environment at a different elevation. One of skill in the art will appreciate that numerous combinations of wireless communication devices 110 and 120 may be used in the example finding scenarios (phone/phone watch/phone, phone/tablet, phone/headset, etc.).

FIG. 2 shows an example wireless communication device 200 according to various example embodiments. The wireless communication device 200 of FIG. 2 may represent the wireless communication device 110 or 120 described with regard to FIG. 1. The wireless communication device 200 may be any type of electronic component that is configured to wirelessly connect to another wireless communication device. A wireless connection may be a short-range communication connection. Non-limiting examples include mobile phones, smartphones, tablet computers, desktop computers, wearables, embedded devices, Internet of Things (IoT) devices, etc.

The wireless communication device 200 may include a processor 205, a memory arrangement 210, a display device 215, an input/output (I/O) device 220, a transceiver 225, an IMU 230 and other components 235. The other components 235 may include, for example, an audio input device, an audio output device, a data acquisition device, cameras, visual inertial odometry (VIO) components, light detection and ranging (LiDAR) sensors, ports to electrically connect to other electronic devices, sensors to detect conditions of the device, etc.

The processor 205 may be configured to execute a plurality of engines for the wireless communication device 200. For example, the engines may perform operations related to locating another wireless communication device such as, but not limited to, determining if another wireless communication device is allowed to find the wireless communication device 200 based on an advertisement received from other wireless communication devices, forming responses to another wireless communication device attempting to find the wireless communication device 200, deriving motion data for the finder, deriving motion data for the findee and generating directions that enable the user of the wireless communication device 200 to locate another device. Examples of these operations will be described in greater detail below.

The above referenced engines being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the wireless communication device 200. The display device 215 may be a hardware component configured to show data to a user, e.g., display user interfaces (UIs), directional arrows, text messages, etc. The I/O device 220 may be a hardware component that enables the user to enter inputs (e.g., to locate another person, to allow find location services to be used, etc.). The display device 215 and the I/O device 220 may be separate components or integrated together such as a touchscreen.

The transceiver 225 may be a hardware component configured to establish a wireless connection with one or more networks or with one or more other wireless communication devices. The transceiver 225 may be configured to use more than one radio access technology. Accordingly, the transceiver 225 may operate on a variety of different frequencies or channels (e.g., set of consecutive frequencies) to communicate with the networks and/or other wireless communication devices. The transceiver 225 may also be configured to use a short-range communication protocol, e.g., Bluetooth. The transceiver 225 may include separate transceiver circuitry for each of a respective type of wireless connection, radio access technology, and/or range of frequencies of operation. The transceiver 225 may comprise transceiver circuitry configured for operating using Bluetooth communication. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

The IMU 230 may be a hardware component comprising one or more sensors. The sensors may include, but are not limited to, one or more gyroscopes and one or more accelerometers. The IMU 230 may collect data such as, but not limited to, acceleration measurements for the wireless communication device 200 and angular velocity measurements of the wireless communication device 200. When the wireless communication device 200 is a findee, the IMU data collected by the IMU 230 may be signaled to the finder where it is used to generate directions that enable the finder to locate the wireless communication device 200. When the wireless communication device 200 is a finder, the IMU data collected by the IMU 230 may be used to generate directions that enable the user of the wireless communication device 200 to locate the findee.

According to some aspects, the example embodiments relate to using IMU data from the finder and/or the findee to generate directions that enable the user of the finder to locate the findee. The example embodiments are described within the context of a find operation initiated by the finder. An example find operation is described below with regard to the methods 300. However, the methods 300 are not intended to limit the example embodiments in any way and is merely provided as a general overview of an example find operation. The example embodiments may be used independently from one another, in conjunction with currently implemented people finder or device finder mechanisms, in conjunction with future implementations of people finder or device finder mechanisms or independently from other people finder or device finder mechanisms.

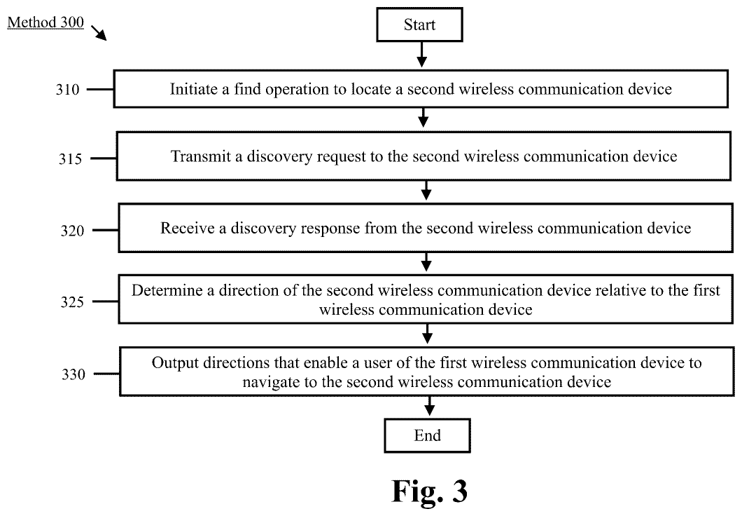

FIG. 3 shows a method 300 for performing a find location operation between the first wireless communication device 110 and the second wireless communication device 120 according to various example embodiments. In this example, the first wireless communication device 110 may be the finder and the second wireless communication device 120 may be the findee.

In 310, the first wireless communication device 110 initiates a find operation to locate the second wireless communication device 120. As will be described in greater detail below, the find operation may be used by the first wireless communication device 110 to generate directions that enable the user of the first wireless communication device 110 to navigate to the second wireless communication device 120. The directions may consist of displaying an arrow graphic on the user interface (UI) of an application running on the first wireless communication device 110 that points in the direction of the second wireless communication device 120. The arrow may automatically update its orientation based on the location of the first wireless communication device 110 relative to the second wireless communication device 120.

Prior to the first wireless communication device 110 initiating the find operation for the second wireless communication device 120, the devices 110-120 and/or the users thereof may have communicated their intentions to form a friendship relationship. Throughout this description, a friendship relationship refers to a configuration where one wireless communication device is permitted to find another wireless communication device using the find operation. For example, the first wireless communication device 110 may be permitted to locate the second wireless communication device 120 and/or the second wireless communication device 120 may be permitted to locate the first wireless communication device 110. The friendship relationship between the first wireless communication device 110 and the second wireless communication device 120 may encompass a state of i) only the first wireless communication device 110 is permitted to operate as a finder and only the second wireless communication device 110 is permitted to operate as a findee, ii) only the second wireless communication device 120 is permitted to operate as a finder and only the first wireless communication device 110 is permitted to operate as a findee or iii) there is a reciprocal relationship where both the first wireless communication device 110 and the second wireless communication device 120 are permitted to operate as a finder and findee. However, reference to the term “friendship relationship” is merely provided for illustrative purposes. Different entities may refer to this concept by a different name.

To provide a general non-limiting example, the wireless communication devices may have a find location application and the users may enter their intention to form a friendship via a user interface (UI) of the application. The wireless communication device 120 and the first wireless communication device 110 may share one or more keys that are used to enable communication between the devices during a find operation. The one or more keys may be exchanged between the first communication device 110 and the second communication device 120 directly using short-range communication or indirectly using a network connection.

In some embodiments, a key associated with the friendship relationship may be a one-to-one key, e.g., the key is unique to the finder/findee friendship and only the friendship pair will know this friendship key and no other device can resolve the finder or findee using the specific friendship key. The users sharing their location can revoke that permission at any time, either offline (e.g., by disabling a specific friendship key) or online (e.g., by indicating to the finder that the friendship key is no longer active). However, reference to a key mechanism is merely provided for illustrative purposes. The example embodiments may utilize any appropriate type of mechanism to manage the settings with regard to the finder and findee relationship between two or more devices.

In 315, the first wireless communication device 110 transmits, to the second wireless communication device 120, one or more signals including a request to initiate a ranging operation. The request may include data related to finding the second wireless communication device 120. For example, the request may include data that is encrypted using a key known to the finder and findee. In some examples, the request may be a Bluetooth advertisement.

After transmitting the request, the first wireless communication device 110 may receive one or more signals from the second wireless communication device 120 that comprises a response indicating that the first wireless communication device 110 is to locate the second wireless communication device 120. The first wireless communication device 110 (e.g., processor) may decode a request based on one or more signals transmitted by the second wireless communication device 120 over a cellular or WiFi network.

In some examples, after transmitting a Bluetooth advertisement comprising the request, the first wireless communication device 110 may perform scanning operations to determine if the second wireless communication device 120 has responded to the Bluetooth advertisements. Like the advertisement operation, the operations may be performed continuously until the findee is located or the user of the finder discontinues attempting to locate the findee.

Prior to 310 or 315, on the findee side, the second wireless communication device 120 may scan for Bluetooth advertisements from other wireless communication devices that are attempting to find the second wireless communication device 120. The scanning operation may be any scanning operation supported by the Bluetooth protocol being executed by the findee. The findee may be triggered to perform the scanning operations for any of a variety of different reasons (e.g., in accordance with a schedule, triggered by a predetermined condition, in response to user input, etc.). In addition, the scanning operations may be performed when the findee is offline, e.g., has no connection to a wireless network and/or in a power saving mode. The scanning operation may be continuous until the user of the findee turns off this capability or until the findee has identified a finder (e.g., first communication device 110). These scanning examples are only provided for illustrative purposes and any appropriate type of scanning operation may be used.

In 320, the first wireless communication device 110 receives a Bluetooth advertisement from the second wireless communication device 120. In this example, it may be assumed that the second wireless communication device 120 received a Bluetooth advertisement transmitted by the first wireless communication device 110 in 315. The second wireless communication device 120 may determine, based on the advertisement and the state of their friendship relationship, that the first wireless communication device 110 is permitted to locate the second wireless communication device 120 using the find operation. The second wireless communication device 120 may then transmit one or more Bluetooth advertisements to the first wireless communication device 110 where at least Bluetooth advertisement is received in 320. The Bluetooth advertisement in 320 may indicate that the second wireless communication device 120 received a Bluetooth advertisement from the first wireless communication device 110 for the find operation.

The exchange of Bluetooth signals in 315-320 may allow the finder and the findee to discovery each other's presence and confirm that the finder it permitted to locate the findee. After this exchange, a more precise location operation may be performed. A more precise location operation may involve the use of a short-range wireless communication protocol. For example, an ultra-wideband (UWB) ranging operation may be used to determine a more precise location of the findee. As will be described in greater detail below, instead of or in addition to the UWB ranging operation, the first wireless communication device 110 may receive information collected by the second wireless communication device 120. The first communication device 110 may receive information directly using a short-range communication protocol (e.g., Bluetooth, etc.) or indirectly through a network connection (e.g., cellular radio access technology, wireless local area network (WLAN), etc.). In some example embodiments, the second wireless communication device 120 may generate the information to be provided to the first communication device. The second wireless communication device 120 may generate the information using data collected by the one or more IMUs of the second wireless communication device 120.

In 325, the first wireless communication device 110 determines a direction of the second wireless communication device 120 relative to the first wireless communication device 110. For example, as mentioned above, the first wireless communication device 110 may perform a UWB ranging operation to determine the direction of the second wireless communication device 120. Alternatively, or in addition to the UWB ranging operation, the first wireless communication device 110 may use other information collected by other components of the first wireless communication device 110 or the second wireless communication device 120 to determine the direction of the second wireless communication device 120. In some examples, this information may include IMU data collected by the first wireless communication device 110 and/or IMU data collected by the second wireless communication device 120 and provided to the first wireless communication device 110 in any appropriate manner.

In 330, the first wireless communication device 110 may output directions that enable a user of the first wireless communication device 110 to navigate to the second wireless communication device 120. In some embodiments, the directions may be an arrow displayed on the UI of an application running on the first wireless communication device 110. The directions may further include, but are not limited to, haptic feedback, audio-based directions and text-based direction. The directions may dynamically update based on the motion of the finder and/or the findee. Therefore, the operations performed in 325-330 may be performed continuously until the findee is located or the user of the finder discontinues attempting to locate the findee.

In some example embodiments of FIG. 3, the ranging operations (e.g., UWB ranging) may be triggered by a discovery mechanism using Bluetooth including using Bluetooth advertisements. In other example embodiments, a discovery mechanism may be deployed over the Internet. The Internet-based discovery mechanism may be referred to herein as an Internet Discovery Service (IDS). In these example embodiments, a request may be sent from the finder device to the target device (or findee device) and, if the finder device receives a response from the target device, UWB ranging is triggered at the target device.

In still further example embodiments, a discovery mechanism may be deployed over a cellular connection. In these example embodiments, a request may be sent from the finder device to the target device (or findee device) using the cellular connection and, if the finder device receives a response from the target device, UWB ranging is triggered at the target device. Furthermore, other types of network connections may also be used to send/receive discovery messages to trigger the ranging operations.

In some example embodiments, the different types of discovery mechanisms (e.g., Bluetooth, IDS, cellular, etc.) may be used in combination. For example, two or more discovery mechanisms may be initiated in parallel and, if either of them is successful, the UWB ranging is triggered.

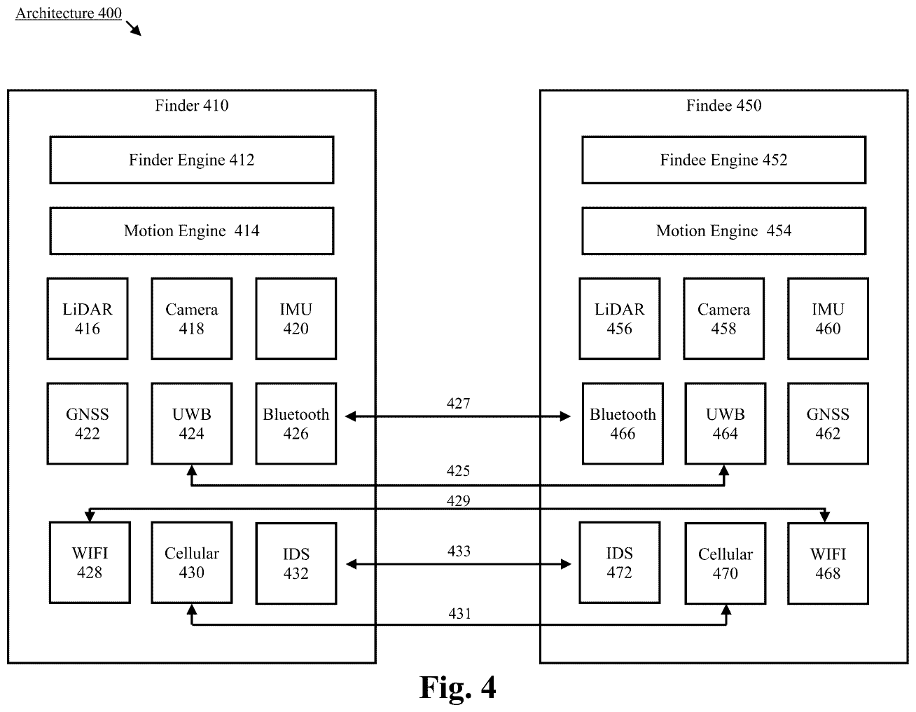

FIG. 4 shows an example architecture 400 for a finder 410 and findee 450 according to various example embodiments. The example architecture will be described with regard to the wireless communication device 200 of FIG. 2.

The architecture 400 provides a general example of the type of components that may interact with one another to enable a finder to locate a findee. The architecture 400 includes a finder 410 and the findee 450. Both the finder 410 and the findee 450 may be represent the wireless communication device 200 described above with regard to FIG. 2.

The finder 410 may include a finder engine 412, a motion engine 414, LiDAR 416, camera 418, IMU 420, global navigation satellite system (GNSS) 422, UWB 424, Bluetooth 426, WIFI 428, cellular 430, and IDS 432. The finder engine 412 may run on a processor and manage operations related to interacting with the user (e.g., receiving and responding to user input via a UI, etc.). In addition, the finder engine 412 may manage operations related to outputting directions to the user, e.g., directional arrow pointing towards the findee 450, haptic feedback directing the user to the findee 450, text-based feedback directing the user to the findee 450, etc.

The motion engine 414 may run on a processor and perform various operations related to deriving location information for the finder 410 and/or the findee 450. The motion engine 414 may receive input from, at least, the LiDAR 416, the camera 418, the IMU 420, the GNSS 422, UWB 424, Bluetooth 426, WIFI 428, cellular 430, and IDS 432.

The motion engine 414 may perform operations such as, but not limited to, performing position estimates of the finder 410 and/or findee 450, performing a ranging estimate between the finder 410 and findee 450, performing time of flight measurements on signals exchanged with the findee 450, executing motion models and performing 3D mapping. In some examples, the motion engine 414 may use synthetic aperture techniques to derive location information for the finder 410 and/or findee 450. In some examples, the motion engine 414 may use machine learning techniques to derive location information for the finder 410 and/or findee 450.

WIFI 428 may represent hardware, software and/or firmware configured to communicate with an access point of a wireless local area network (WLAN). Information received from the WLAN or any other appropriate type of wireless network (e.g., cellular) may be used to determine a direction of the findee 450. However, the finder 410 does not require a network connection and may locate the findee 450 while offline. In some embodiments, information derived from a WLAN environment such as, but not limited to, WLAN or WIFI access point names (APNs) may also be used to determine a direction of the findee 450. Other information exchanged over the link 429 may include a request/response used to trigger the ranging operations.

Bluetooth 426 may represent hardware, software and/or firmware configured to perform short-range communication with the findee 450. This may include exchanging advertisements with the findee 450 over link 427 as described above with regard to the method 300.

UWB 424 may represent hardware, software and/or firmware configured to perform a ranging operation with the findee 450. This may include exchanging ranging data with the findee 450 over link 425. In some scenarios, the ranging operation may provide a more precise location of the findee 450.

GNSS 422 may represent hardware, software and/or firmware configured to receive positioning information collected by satellites. The positioning information may correspond to the finder 410 and/or findee 450 and may be used to determine a direction of the findee 450. The information collected by the WIFI 428, cellular 430, IDS 432, Bluetooth 426, UWB 424 and GNSS 422 may be provided to the motion engine 414.

LiDAR 416 may represent one or more LiDAR sensors comprising hardware, software and/or firmware configured to collect information about the physical surroundings and environment of the finder 410. Camera 418 may represent one or more camera comprising hardware, software and/or firmware configured to collect information about the physical surroundings and environment of the finder 410. Data collected using LiDAR 416 and/or camera 418 may be used for operations such as, but not limited to, three-dimensional mapping of a physical environment, tracking physical objects, deriving motion information of the finder 410 and deriving location information of the finder 410.

IMU 420 may represent one or more IMU sensors comprising hardware, software and/or firmware configured to generate information about the motion of the finder 410. The IMU 420 may generate data such as, but not limited to, acceleration measurements of the finder 410 and angular velocity measurements of the finder 410.

Cellular 430 may represent hardware, software and/or firmware configured to communicate with a cellular network. Information received from the cellular network may be used to determine a direction of the findee 450. However, the finder 410 does not require a cellular network connection and may locate the findee 450 while offline. In some embodiments, information derived from a cellular environment such as, but not limited to, cell identifications (IDs), may also be used to determine a direction of the findee 450. Other information exchanged over the link 431 may include a request/response used to trigger the ranging operations.

The findee 450 may include a findee engine 452, a motion engine 454, LiDAR 456, camera 458, IMU 460, global navigation satellite system (GNSS) 462, UWB 464, Bluetooth 466, WIFI 468, cellular 470, and IDS 472. The findee engine 452 may run on a processor and manage operations related to interacting with the user (e.g., receiving and responding to user input via a UI, etc.). In some embodiments, there may be a reciprocal relationship between wireless communication devices and each device may simultaneously be a finder and a findee for one another.

The motion engine 454 may run on a processor and perform various operations related to deriving location information for the finder 410 and/or the findee 450. The motion engine 454 may receive input from, at least, the LiDAR 456, the camera 458, the IMU 460, the GNSS 462, UWB 464, Bluetooth 466, WIFI 468, cellular 470, and IDS 472.

The motion engine 454 may perform operations such as, but not limited to, performing position estimates of the finder 410 and/or findee 450, performing a ranging estimate between the finder 410 and findee 450, performing time of flight measurements on signals exchanged with the finder 410, executing motion models and performing 3D mapping. In some examples, the motion engine 454 may use synthetic aperture techniques to derive location information for the finder 410 and/or findee 450. In some examples, the motion engine 454 may use machine learning techniques to derive location information for the finder 410 and/or findee 450. The information derived by the motion engine 454 may be provided to the finder 410 over the Bluetooth link 427, the UWB link 425, the cellular link 431, the IDS link 433 or in any other appropriate manner.

WIFI 468 may represent hardware, software and/or firmware configured to communicate with an access point of a WLAN. However, a network connection is not required and the findee 450 may be located while offline.

Bluetooth 466 may represent hardware, software and/or firmware configured to perform short-range communication with the finder 410. This may include exchanging advertisements with the finder 410 over link 427 as described above with regard to the method 300.

UWB 464 may represent hardware, software and/or firmware configured to perform a ranging operation with the finder 410. This may include exchanging ranging data with the finder 410 over link 425. In some scenarios, the ranging operation may provide a more precise location of the finder 410.

GNSS 462 may represent hardware, software and/or firmware configured to receive positioning information collected by satellites. The positioning information may correspond to the finder 410 and/or findee 450. The information collected by the WIFI 468, cellular 470, IDS 472, Bluetooth 466, UWB 464 and GNSS 462 may be provided to the motion engine 454. In addition, information collected by the WIFI 468, cellular 470, IDS 472, Bluetooth 466, UWB 464 and GNSS 462 may be provided to the motion engine 454, may be provided to the finder 410 over the Bluetooth link 427, the UWB link 425 or in any other appropriate manner.

LiDAR 456 may represent one or more LiDAR sensors comprising hardware, software and/or firmware configured to collect information about the physical surroundings and environment of the findee 450. Camera 458 may represent one or more camera comprising hardware, software and/or firmware configured to collect information about the physical surroundings and environment of the findee 450. Data collected using LiDAR 456 and/or camera 458 may be used for operations such as, but not limited to, three-dimensional mapping of a physical environment, tracking physical objects, deriving motion information of the findee 450 and deriving location information of the findee 450.

Cellular 470 may represent hardware, software and/or firmware configured to communicate with a cellular network. Information received from the cellular network may be used to determine a direction of the findee 450. However, the finder 410 does not require a cellular network connection and may locate the findee 450 while offline. In some embodiments, information derived from a cellular environment such as, but not limited to, cell identifications (IDs), may also be used to determine a direction of the findee 450.

IMU 460 may represent one or more IMU sensors comprising hardware, software and/or firmware configured to collect information about the motion of the finder 410. The IMU 460 may collect data such as, but not limited to, acceleration measurements of the finder 410 and angular velocity measurements of the finder 410. The information collected by the LiDAR 456, the camera 458 and the IMU 460 may be provided to the motion engine 454. In addition, the information collected by the LiDAR 456, camera 458 and the IMU 460 may be provided finder 410 over the Bluetooth link 427, the UWB link 425 or in any other appropriate manner.

Example embodiments may be used to generate an accurate arrow at the finder and determine an accurate walking velocity of the user in any environmental condition. In some embodiments, the finder may generate an arrow based on core location information, odometry data and/or global positioning information. Core location information may include a combination camera data (images, video, etc.), IMU data, VIO and APNs.

According to some aspects, the example embodiments introduce techniques for generating directions that enable a finder to locate a findee using data collected by the IMUs of the finder and/or the findee. In the examples provided below, the directions are described with regard to an arrow that is displayed on a UI of the finder. The arrow is configured to dynamically update based on the motion of the finder and/or findee.

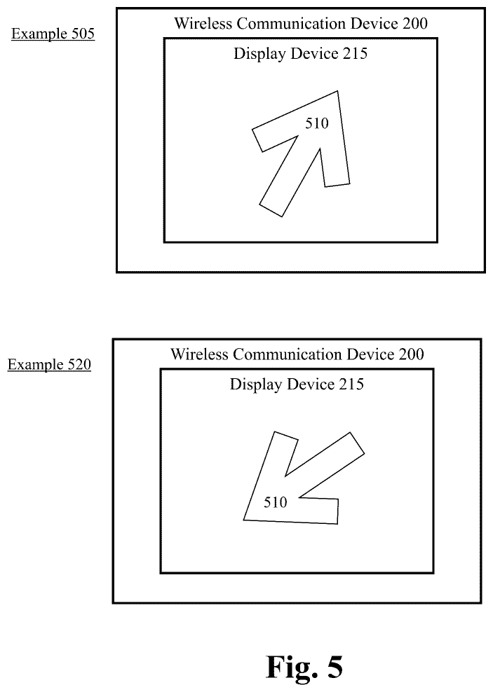

Examples of an arrow directing the finder to the findee according to various example embodiments is shown in FIG. 5. Example 505 shows a display device 215 of the communication device 200 at a first time. The communication device 200 is operating as a finder and its display device 215 shows a graphic of an arrow 510. The arrow 510 is configured to point in the direction of the findee relative to the location of the finder. This allows the user to walk towards the findee (or move towards the findee in any other manner). In this example, the arrow 510 is a 2D graphic. However, in an actual operating scenario the arrow may be a three-dimensional object and/or enhanced with additional graphics that provide further direction information that enables the user to navigate to the findee.

Example 520 shows a display device 215 of the communication device 200 at a second time that is subsequent to the first time. In between the first time of example 505 and the second time of example 520, at least one of the finder or the findee has moved. As a result, the arrow 510 has moved so that it is still pointing in the direction of the findee relative to the location of the finder. The examples show in FIG. 5 are provided as a general example of the type of information that may be provided to the user to enable the user to navigate towards the findee. While the example embodiments are described with regard to arrow generation, the example techniques introduced herein may be used to generate any appropriate type of output (e.g., haptic feedback, static graphics, dynamic graphics, audio alerts, text alerts, lights, etc.) that is configured to enable a finder to locate a findee in a physical environment.

In some example embodiments, an issue may occur that prevents the finder from displaying an accurate arrow (or any arrow at all). For instance, factors such as crowded environments, distance between finder and findee, a lack of stationary objects, multi-path environments and occluding the view of the camera have been identified to have a negative impact on arrow generation when using conventional approaches. Inaccurate, slow or unavailable directions have a negative impact on the user experience associated with using the finder and findee functionality.

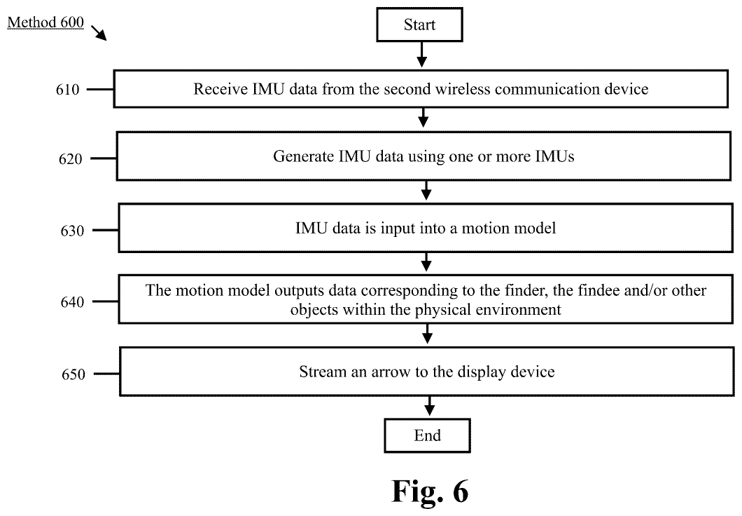

FIG. 6 shows a method 600 for arrow generation according to various example embodiments. In this example, the method 600 may occur during the method 300 and is described from the perspective of the wireless communication device 110 operating as a finder and the wireless communication device 120 operation as the findee.

In 610, the first wireless communication device 110 receives IMU data from the second wireless communication device 120. The IMU data may include and/or be derived based on information collected by one or more IMUs of the second wireless communication device 120. The second communication device 120 may transmit signaling to the first communication device 110 that includes an indication of IMU data. The IMU data may include measurements of parameters relative to the second wireless communication device 120 or a movement of the second wireless communication device 120, for example, relative to an acceleration or and/or an angular velocity of the second wireless communication device 120. The IMU data for the second wireless communication device may include acceleration measurements for the second wireless communication device 120 and angular velocity measurements for the second wireless communication device 120.

In some examples, the IMU data may be provided (e.g., transmitted by the second wireless communication device 120 to the first wireless communication device 110 as part of the Bluetooth advertisement received in 320 of the method 300. In other examples, the IMU data may be provided directly over a different short-range communication signal, indirectly over a network connection (e.g., cellular, WLAN, etc.) or during the UWB ranging procedure.

In 620, the first wireless communication device 110 generates IMU data using one or more IMU sensors. The IMU data may include measurements of parameters relative to the first wireless communication device 110 or a movement of the first wireless communication device 110, for example, relative to an acceleration or and/or an angular velocity of the first wireless communication device 110. The IMU data for the first wireless communication device 110 may include acceleration measurements for the first wireless communication device 110 and angular velocity measurements for the first wireless communication device 110. While this example embodiment describes the use of IMU data collected from both the finder and the findee, the example embodiments are not limited to this example and may be used with IMU data from the findee and/or finder.

In some embodiments, the particle dynamics of the motion model may be configured to convey a percentage of the particles being stationary for a particular measurement period. In one non-limiting example, 20% of the particles may be stationary. For the remaining non-stationary particles, an initial state can vary based on velocity and direction of travel. In one non-limiting example, the particles may have a mean initial velocity of 0.7 meters per second (m/s) with a standard deviation of 0.5 m/s and a random direction of travel. In addition, a percentage of the moving particles may be redirected +/−90 degrees within the coordinate system or 180 degrees during each measurement or a subset of measurements. In one non-limiting example, 5% of the moving particles may change direction every measurement. In another non-limiting example, there may be a velocity change of 0.1 m/s gaussian noise every measurement.

In some embodiments, the particle dynamics of the motion model are configured where a percentage of the particles are stationary. In one non-limiting example, 20% of the particles may be stationary. For the remaining moving particulars, an initial state can vary based on velocity and direction of travel. In one non-limiting example, the particles may have a mean initial velocity is 0.7 meters per second (m/s) with a standard deviation of 0.5 m/s and a random direction of travel. In addition, a percentage of the moving particles may be redirected +/−90 degrees within the coordinate system or 180 degrees during each measurement or a subset of measurements. In one non-limiting example, 5% of the moving particles may change direction every measurement. In another non-limiting example, there may be a velocity change of 0.1 m/s gaussian noise every measurement.

The above examples are not intended to limit the example embodiments to any specific parameter value. The particle filter may use any appropriate type of particle states including, but not limited to, two-dimensional coordinates, velocity and direction of travel. Further, the particle filter dynamics may be configured with a first portion of stationary particles comprising any appropriate number of particles and a second portion of moving particles comprising any appropriate number of particles. Among the second portion of moving particles, a subset of particles comprising any appropriate number of particles may be redirected at any appropriate angle.

In 640, the motion model outputs motion data corresponding to the finder, the findee and/or other objects within the physical environment. In some embodiments, angular data may be derived from the two-dimensional coordinate (XZ) variance of the particles of the motion model based on measured range.

In 650, the first communication device 110 streams an arrow to its display device. The first communication device 110 may display the arrow on its display device. As mentioned above, the arrow may indicate where the findee is located relative to the finder. The orientation and appearance of the arrow on the display device may be based on the motion model. For example, the angular data derived from the XZ variance may define an arrow generation threshold. The arrow may move based on a change in the angular data.

The method 600 is a continuous process that allows for incrementally estimating the pose of the finder relative to the location of the findee and thus, the angle or direction of the arrow.

In some embodiments, the IMU sensor data may be used in conjunction with data collected by one or more cameras of the finder and/or the findee. The camera data of the findee may be provided to the finder along with the IMU data or in any other appropriate manner (e.g., short-range communication, network connection, etc.). The camera data and the IMU data may be used for visual-inertial odometry (VIO) to estimate the pose and/or velocity of at least one of the finder or the findee.

In some embodiments, the particle filter may use particle ranges and VIO trajectories on both sides to orient findee trajectory relative to the finder. This may include deriving a particle state for finder trajectory rotation relative to findee. For example, instead of XZ variance, there may be XYZ variance where Y represents an angle for finder trajectory rotation relative to findee.

According to some aspects, the example embodiments may use a trigger condition to activate the collection of IMU data from the findee for arrow generation. For instance, a wireless communication device may be configured with multiple operating modes. In a first operating mode, a finder may not rely on IMU data to determine the pose of the finder relative to the findee. Instead, the finder may rely on information collected from sources other than IMU of the finder and/or findee (e.g., UWB ranging, LiDAR, cameras, etc.).

In a second operating mode, the finder may consider IMU data to determine the pose of the finder relative to the findee. The IMU data may be used in conjunction with data collected or derived from any other appropriate source. When in the first operating mode, the wireless communication device (e.g., 110) may identify a condition indicating an issue with the performance of arrow generation and/or conditions indicating that an issue with arrow generation is imminent which triggers the finder to switch to the second operating mode. For example, the trigger condition may be a number or percentage of stationary objects in the physical environment that is below a threshold value. In another example, the trigger condition may be a type of location (e.g., stadium, theme park, landmark, etc.) and/or a number of people in the physical environment that is above a threshold value. In a further example, the trigger condition may be a distance between the finder and the findee that is above a threshold value. The above examples are not intended to limit the example embodiments in any way and the example embodiments may use any appropriate trigger condition.

In some embodiments, the first operating mode is a default operating mode and the communication device switches to the second operating mode based on a trigger condition. In other embodiments, the second operating mode is the default operating mode and the communication device switches to the first operating mode based on a trigger condition. Within the context of the method 300, the switch may occur before or after the find operation is initiated at the finder in 310. In some embodiments, the finder may explicitly indicate the switch to the findee over the short-range connection or over a network connection (e.g., cellular, WLAN, etc.). In other embodiments, the findee may initiate the switch to the second operating mode by sending IMU data to the finder. However, the example embodiments do not require a switch between various operating modes and arrow generation may be based on IMU data each time the find operation is performed.

### Examples

In a first example, a method, comprising generating, for transmission to a second wireless communication device, a request to initiate a ranging operation, processing, based on one or more signals received from the wireless communication device, a response indicating that the apparatus is to locate the wireless communication device, collecting inertial measurement unit (IMU) data, from at least one of the apparatus or the wireless communication device and generating an arrow to be displayed based on at least the IMU data, the arrow indicating a direction of the wireless communication device relative to the apparatus.

In a second example, the method of the first example, wherein IMU data comprises a first set of IMU data collected by a component of the apparatus and a second set of IMU data collected by the wireless communication device, the method further comprising processing, based on signaling received from the wireless communication device, the second set of IMU data.

In a third example, the method of the first example, wherein IMU data comprises a first set of IMU data collected by a component of the apparatus and a second set of IMU data collected by the wireless communication device, the method further comprising processing, based on signaling received from the wireless communication device over a cellular network connection, the second set of IMU data.

In a fourth example, the method of the first example, wherein IMU data comprises a first set of IMU data collected by a component of the apparatus and a second set of IMU data collected by the wireless communication device, the method further comprising processing, based on signaling received from the wireless communication device over a wireless local area network (WLAN) connection, the second set of IMU data.

In a fifth example, the method of the first example, wherein generating the arrow to be displayed based on at least the IMU data includes using a motion model to determine an angle of the arrow.

In a sixth example, the method of the fifth example, wherein the motion model includes multiple particles, each particle with multiple states comprising at least i) a coordinate location state, ii) a velocity state and iii) a direction of travel state.

In a seventh example, the method of the sixth example, wherein a first portion of the particles are stationary and a second portion of the particles are moving.

In an eighth example, the method of the seventh example, wherein a subset of the second portion of the particles is redirected to change direction by 90 degrees or 180 degrees every measurement.

In a ninth example, the method of the eighth example, wherein the angle of the arrow is derived from the coordinate location state variance of the particles of the motion model.

In a tenth example, the method of the sixth example, wherein generating the arrow to be displayed is further based on visual inertial odometry (VIO) trajectories.

In an eleventh example, the method of the tenth example, wherein the coordinate location state comprises a trajectory rotation of the first wireless communication device relative to the second wireless communication device.

In a twelfth example, the method of the first example, wherein generating an arrow to be displayed is further based on camera data.

In a thirteenth example, the method of the first example, wherein generating an arrow to be displayed is further based on global positioning data.

In a fourteenth example, the method of the first example, wherein generating an arrow to be displayed is further based on access point names (APNs) identified by at least one of the apparatus or the wireless communication device.

In a fifteenth example, the method of the first example, wherein generating an arrow to be displayed is further based on global positioning data.

In a sixteenth example, the method of the first example, further comprising triggering, prior to collecting the IMU data, a switch from a first mode of operation to a second mode of operation, wherein in the second mode of operation the apparatus is configured to generate the arrow to be displayed using IMU data and in the first mode of operation the apparatus is configured to generate the arrow to be displayed without using the IMU data.

In a seventeenth example, the method of the sixteenth example, wherein triggering the switch from the first mode of operation to the second mode of operation is based on at least one of, an indication of crowded environment, a distance between the apparatus and the second wireless communication device, a type of location and an indication that one or more cameras are occluded.

In an eighteenth example, the method of the first example, wherein the request is transmitted via a short-rage connection, a Wi-Fi connection, an Internet connection or a cellular connection.

In a nineteenth example, a processor configured to perform any of the methods of the first through eighteenth examples.

In a twentieth example, a wireless communication device configured to perform any of the methods of the first through eighteenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a second wireless communication device, a request to initiate a ranging operation;
process, based on one or more signals received from the wireless communication device, a response indicating that the apparatus is to locate the wireless communication device;
collect inertial measurement unit (IMU) data, from at least one of the apparatus or the wireless communication device; and
generate an arrow to be displayed based on at least the IMU data, the arrow indicating a direction of the wireless communication device relative to the apparatus.

2. The apparatus of claim 1, wherein IMU data comprises a first set of IMU data collected by a component of the apparatus and a second set of IMU data collected by the wireless communication device, the processing circuitry further configured to:
process, based on signaling received from the wireless communication device, the second set of IMU data.

3. The apparatus of claim 1, wherein IMU data comprises a first set of IMU data collected by a component of the apparatus and a second set of IMU data collected by the wireless communication device, the processing circuitry further configured to:
process, based on signaling received from the wireless communication device over a cellular network connection, the second set of IMU data.

4. The apparatus of claim 1, wherein IMU data comprises a first set of IMU data collected by a component of the apparatus and a second set of IMU data collected by the wireless communication device, the processing circuitry further configured to:
process, based on signaling received from the wireless communication device over a wireless local area network (WLAN) connection, the second set of IMU data.

5. The apparatus of claim 1, wherein generating the arrow to be displayed based on at least the IMU data includes using a motion model to determine an angle of the arrow.

6. The apparatus of claim 5, wherein the motion model includes multiple particles, each particle with multiple states comprising at least i) a coordinate location state, ii) a velocity state and iii) a direction of travel state.

7. The apparatus of claim 6, wherein a first portion of the particles are stationary and a second portion of the particles are moving.

8. The apparatus of claim 7, wherein a subset of the second portion of the particles is redirected to change direction by 90 degrees or 180 degrees every measurement.

9. The apparatus of claim 8, wherein the angle of the arrow is derived from the coordinate location state variance of the particles of the motion model.

10. The apparatus of claim 6, wherein generating the arrow to be displayed is further based on visual inertial odometry (VIO) trajectories.

11. The apparatus of claim 10, wherein the coordinate location state comprises a trajectory rotation of the first wireless communication device relative to the second wireless communication device.

12. The apparatus of claim 1, wherein generating an arrow to be displayed is further based on camera data.

13. The apparatus of claim 1, wherein generating an arrow to be displayed is further based on global positioning data.

14. The apparatus of claim 1, wherein generating an arrow to be displayed is further based on access point names (APNs) identified by at least one of the apparatus or the wireless communication device.

15. The apparatus of claim 1, wherein generating an arrow to be displayed is further based on global positioning data.

16. The apparatus of claim 1, wherein the processing circuitry is further configured to:
trigger, prior to collecting the IMU data, a switch from a first mode of operation to a second mode of operation, wherein in the second mode of operation the apparatus is configured to generate the arrow to be displayed using IMU data and in the first mode of operation the apparatus is configured to generate the arrow to be displayed without using the IMU data.

17. The apparatus of claim 16, wherein triggering the switch from the first mode of operation to the second mode of operation is based on at least one of, an indication of crowded environment, a distance between the apparatus and the second wireless communication device, a type of location and an indication that one or more cameras are occluded.

18. The apparatus of claim 1, wherein the request is transmitted via a short-rage connection, a Wi-Fi connection, an Internet connection or a cellular connection.

19. A method, comprising:
generating, for transmission to a second wireless communication device, a request to initiate a ranging operation;
processing, based on one or more signals received from the wireless communication device, a response indicating that the apparatus is to locate the wireless communication device;
collecting inertial measurement unit (IMU) data, from at least one of the apparatus or the wireless communication device; and
generating an arrow to be displayed based on at least the IMU data, the arrow indicating a direction of the wireless communication device relative to an apparatus performing a method.

20. The method of claim 19, wherein IMU data comprises a first set of IMU data collected by an apparatus performing the method and a second set of IMU data collected by the wireless communication device, the method further comprising processing, based on signaling received from the wireless communication device, the second set of IMU data.
